(19) United States
(12) Patent Application Publication
(10) Pub. No.: US 2003/0101375 A1
(43) Pub. Date: May 29, 2003

(54) Method for determining the cause of a fault in a medical device, and a medical device

(76) Inventor: Wilfried Hohn, Grossenseebach (DE)

Correspondence Address: YOUNG & THOMPSON, 745 SOUTH 23RD STREET 2ND FLOOR, ARLINGTON, VA, 22202

(21) Appl. No.: 10/269,063

(22) Filed: Oct. 11, 2002

(30) Foreign Application Priority Data
Oct. 11, 2001 (DE) 101 50 427.6

(51) Int. Cl. H04L 1/22

(52) U.S. Cl. 714/25

(57) ABSTRACT

A method for determining the cause of a fault that, during the operation of a medical device (1), can occur in the medical device (1). Here, there are stored continuously in a data memory (3, 4) data that are required for an analysis of the operations in the medical device (1) that have proceeded before the occurrence of the fault. The invention also relates to a medical device (1) that has such a data memory (3, 4).

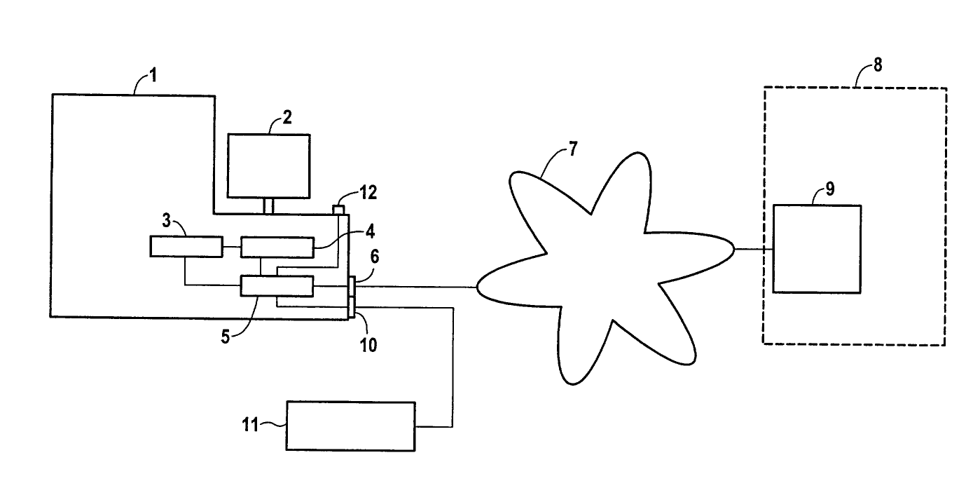

### FIELD OF THE INVENTION

The invention relates to a method for determining the cause of a fault that, during the operation of a medical device, can occur in the medical device. The invention also relates to the configuration of a medical device in order to be able to determine the cause of a fault that has occurred in the medical device.

### BACKGROUND OF THE INVENTION

The complexity of medical devices, which are taken to mean medical installations, systems and units, is continuously increasing because of the rising number of software units in the devices, the increasing functionality of the devices and the interconnection of different medical devices, for example to form work stations. If a fault occurs in such a complex medical device, the search for the cause of the fault is correspondingly difficult. Problems arising are, moreover, frequently of a sporadic nature and cannot be easily understood. The situation is frequently the same with statements from customers or users of medical devices relating to faults occurring in the medical devices. The search for the cause of a fault is therefore generally complicated and tedious, since the person charged with clearing the fault has to work intensively with hypothetical assumptions.

DE 100 57 626 A1 describes a method for an imaging system having an x-ray tube unit, in the case of which method certain information and/or communications available to the system and referring to the operation of the x-ray tube unit are stored in a writable memory. The stored operation information of the x-ray tube unit can be used for a critical analysis in which the operational cycle and also the defective cycle of the x-ray tube unit can be simulated.

DE 689 20 462 T2 discloses a method and a system for online problem solving in a data processing system of a customer by means of a central remote maintenance system. In this case, a range of hardware and software devices cooperate in a customer data processing system and in a central maintenance system that are interconnected by an integral transmission device, in order to create a continuous cycle from the occurrence of a fault in a customer system up to the resolution of the fault.

### SUMMARY OF THE INVENTION

It is the object of the invention to specify a method and a medical device of the type mentioned at the beginning in such a way that the search for the cause of a fault is simplified.

According to the invention, this object is achieved by a method for determining the cause of a fault that, during the operation of a medical device, can occur in the medical device, in which method data that are required for an analysis of the operations that have proceeded before the occurrence of a fault in the medical device are stored over a specific time period in a first, provisional data memory, the content of the first, provisional data memory being transferred into a second data memory after the occurrence of a fault. Thus, according to the invention, during the operation of the medical device data that permit an analysis of the operations in the medical device are stored continuously. If a fault occurs in the medical device, the stored data can be used to determine the cause of the fault without having to resort to hypothetical assumptions. The stored data can be used to reconstruct operating states that the medical device has assumed before the occurrence of the fault and during the occurrence of the fault, and the cause of the malfunctioning of the medical device can be determined systematically.

The data required for an analysis of the operations in the medical device are stored in this case over a specific time period in a first, provisional data memory. For example, the provisional data memory can be designed in such a way that it can store operating data of the medical device of half an operating hour of the medical device. The memory operates in this case according to the FIFO (first-in first-out) principle, and so data stored in the provisional data memory are always only data that relate to the current operations of the last half operating hour of the medical device.

After the occurrence of a fault, the content of the first, provisional data memory is transferred into a second data memory. In this way, the entire content of the first, provisional data memory is saved in the second data memory in order to be able to undertake an analysis of the operations in the medical device that have proceeded before the occurrence and during the occurrence of the fault. If the fault occurring is not a fault that precludes the further operation of the medical device, the latter can continue to be operated, and in this case, furthermore, data that are required for an analysis of the operations in the medical device are buffered continuously in the provisional data memory. Thus, in this case it is possible, even given the occurrence of a second fault, for the content of the provisional data memory to be transferred after the occurrence of the second fault into the second or else into a third data memory such that the cause of the second fault can also be determined with the aid of the stored data.

Variants of the invention provide that the transfer of the content of the first provisional data memory into the second data memory can be prompted manually or automatically. Manual prompting of the transfer of the content of the first provisional data memory is always recommended whenever a person is supervising the operation of the medical device. As soon as the person records a faulty mode of operation of the medical device, said person can prompt the transfer of the content of the first provisional data memory into the second data memory, for example by actuating an appropriate trigger key. If the medical device is not assigned any operator or monitor, the transfer of the content of the first provisional data memory into the second data memory is preferably prompted automatically, operating data generated inside the medical device being compared with desired operating data of the medical device, and the transfer of the content being prompted in the event of significant deviation.

According to one variant of the invention, the data that are required for an analysis of the operations in the medical device are data that reproduce operating states of the medical device, dynamic registers, data that, for example, an operator has input at the medical device, data or actions generated by the medical device, and screen displays or image and video data generated with the medical device.

Another variant of the invention provides that the content of the first, provisional data memory, or the content of the second data memory, is transmitted to a computing device of a service center. In this way, an expert not located in situ, that is to say at the operating location of the medical device, can use the stored data to undertake a remote analysis of the operations in the medical device and determine the cause of the fault from a distance. Since, in particular, it is possible to clear software faults from a distance, for example by entering a revised program version into the medical device, the outlay for service work on medical devices can be greatly reduced by diminished journeys by service technicians. Thus, as a rule, it is still necessary to visit the medical device only whenever a hardware fault occurs in the medical device.

In accordance with one variant of the invention, externally stored operating data of the medical device, that is to say operating data on storage media that are located outside the medical device, can be read once more into the medical device or into a device similar to the medical device in order to analyze the operations in the medical device. It is therefore possible to use the medical device or a device operating similarly in functional terms to go through the operations in the medical device before the occurrence of the fault in a stepwise fashion on the device itself or on the device similar to it, in order in this way to determine the cause of the fault.

The object of the invention is also achieved by a medical device having a first, provisional data memory in which the data required to determine the cause of a fault that, during the operation of the medical device, can occur in the medical device and required for an analysis of the operations that have proceeded in the medical device before the occurrence of the fault can be stored over a specific time period, and having a second data memory into which the content of the first, provisional data memory can be transferred after the occurrence of the fault.

Thus, a medical device configured in such a way can be used to buffer continuously data that describe operating states of the medical device, in order to be able to analyze these data upon the occurrence of a fault during the operation of the medical device when searching for the cause of the fault. The transfer of the content of the first provisional data memory into the second data memory can, as already mentioned, be triggered manually by activating an actuating device. However, it is also possible for a computing device of the medical device to monitor the operation of the medical device and, in the event of establishing a fault, to trigger the transfer of the content of the first, provisional data memory into the second data memory automatically.

In order to be able to analyze the content of the first provisional data memory or the content of the second data memory remotely, that is to say at a location differing from the operating location of the medical device, the medical device can be connected to a communications network via which the memory content can be transmitted to a computing device of a service center. According to another variant of the invention, the medical device also has an interface via which externally stored data, that is to say, for example, data that had been transmitted to the service center, can be read once more into the medical device in order to analyze the operations in the medical device, such that the cause of the fault can be determined at the medical device itself by means of a stepwise procedure.

### BRIEF DESCRIPTION OF THE DRAWING

An exemplary embodiment of the invention is illustrated in the attached schematic drawing, which shows a medical device according to the invention that can be used to execute the method according to the invention.

### DETAILED DESCRIPTION OF THE INVENTION

In the case of the present exemplary embodiment, the medical device is a magnetic resonance machine 1. The magnetic resonance machine 1 is provided for examining patients (not illustrated in more detail). The magnetic resonance machine 1 has, in a way known per se, operating devices (not illustrated in more detail) for operating the magnetic resonance machine 1, and a visual display unit 2 on which operating menus as well as images obtained with the magnetic resonance machine 1 can be displayed.

As shown in the figure, the magnetic resonance machine 1 comprises a first data memory 3, a second data memory 4 and a computing device 5. The computing device 5 is connected via a first interface 6 to a communications network 7 which can be the Internet, for example. Likewise connected to the communications network 7 is a computing device 9 arranged in a service center 8. The service center 8 is operated in the case of the present exemplary embodiment by the manufacturer of the magnetic resonance machine 1, and carries out service work for the medical devices sold or made available to customers by the manufacturer. In the case of the present exemplary embodiment, the service center 8 carries out service work for the operator of the magnetic resonance machine 1. In addition to the interface 6, the magnetic resonance machine 1 has a second interface 10, which can be, for example, a serial or parallel interface to which a computer can be connected. Externally stored data can be read into the magnetic resonance machine 1 via this interface 10 in order to analyze the operations in the magnetic resonance machine 1. In the case of the present exemplary embodiment, the laptop 11 of a service technician not illustrated in the figure and belonging to the service center 8 is connected with the aid of a connecting cable.

During the operation of the magnetic resonance machine 1, data are firstly continuously buffered in the first, provisional data memory 3, which, upon the occurrence of a fault, are required for a later analysis of the operations in the magnetic resonance machine 1. Thus, if a fault occurs during the operation of the magnetic resonance machine 1, it is therefore finally possible to determine the cause of the fault with the aid of the data initially stored in the first, provisional data memory 3. In order not to have to buffer unnecessarily large quantities of data, it is preferred to use the FIFO (first-in first-out) principle for buffering, which means that it is always only current data that are buffered for a specific time period in the first, provisional data memory 3. In the case of the present exemplary embodiment, there are buffered in the first, provisional data memory 3 data that belong to operations in the magnetic resonance machine 1 that reach approximately half an hour into the past.

Finally, if a fault occurs on the magnetic resonance machine 1, an operator (not illustrated explicitly in the figure) of the magnetic resonance machine 1 can actuate a switch 12 to prompt the transfer of the content of the first, provisional data memory 3 into the second data memory 4. Consequently, there are present in the data memory 4 data relating to operations in the magnetic resonance machine 1 that, as already mentioned, reach approximately half an hour into the past and also contain the fault event.

The triggering of the transfer of the content of the first, provisional data memory 3 into the second data memory 4 need not, however, necessarily be performed manually by actuating the switch 12, but can also be prompted in an automated fashion by the computing device 5, which in this case monitors the current operating data of the magnetic resonance machine 1 for the occurrence of a fault and, in the event of the establishment of a fault, for example where data lie outside their tolerance range, prompts the transfer of the content of the first, provisional data memory 3 into the second data memory 4. The data stored in the data memories 3 and 4 are data that reproduce operating states of the magnetic resonance machine 1, dynamic registers, input data, input, for example, via keyboards or other operating devices, by operators, data or actions generated by the magnetic resonance machine 1, in particular after user inputs, and screen displays of the magnetic resonance machine 1 and image or video data that had been generated with the magnetic resonance machine 1. Consequently, there are available for an analysis of the cause of a fault video images, images of patients, input commands and statistical data, and so a person seeking the cause of the fault can view video images and patient images that the operator of the magnetic resonance machine 1 has seen before and during the occurrence of the fault, and can interpret which inputs the operator has executed and which consequences have resulted therefrom.

The principle of the use of two different data memories, specifically a first, provisional data memory 3 and a second data memory 4, in this case offers the possibility that, upon the occurrence of a fault that does not necessarily require a stoppage of the magnetic resonance machine 1, the magnetic resonance machine 1 can be operated further in such a way that data that are required for an analysis of the operations in the magnetic resonance machine 1 are buffered continuously in the first, provisional data memory 3. If a second fault occurs, it is possible for data that reach half an hour into the past and are stored in the first, provisional data memory 3 to be transferred in turn into the second data memory 4 by being prompted manually or automatically by the computing device 5, in order subsequently to be able to determine the cause of the occurrence of the second fault. These data relating to the second fault are, of course, stored in a different memory section than the data relating to the first fault.

In order to analyze the data stored in the second data memory 4, or else the data stored in the first, provisional data memory 3, these can be transmitted via the communications network 7 to the computing device 9 of the service center 8, so that a service technician, not illustrated explicitly in the figure, of the service center 8 can determine from the service center 8 the cause of a fault that has occurred. If the fault is not a malfunction of a hardware component on the magnetic resonance machine 1, and so the fault is present, for example, in a software component, this fault can thus be removed remotely, that is to say from a distance, for example by entering new software, or else only a new software component, into the magnetic resonance machine 1 via the communication network 7 and the interface 6, doing so from the service center 8, in the concrete case from the computing device 9.

If the fault is a hardware-related fault that requires the deployment of a service technician at the operating location of the magnetic resonance machine 1, this technician, equipped with a laptop 11, for example, can enter the data transmitted to the service center 8 into the magnetic resonance machine 1 again via the interface 10 and follow the operations up to the occurrence of the fault directly on the magnetic resonance machine 1 in order to establish the cause of the fault and to remove the cause of the fault. It is also possible to dispense with entering the data in this case if the data relevant to the respective fault are still available to the service technician in the data memory 4 of the magnetic resonance machine.

In the case of externally stored data, the data need not necessarily be entered once more into the magnetic resonance machine 1 in order to determine the cause of a fault in the magnetic resonance machine 1. Rather, the data can also be entered into a unit similar to the magnetic resonance machine 1, for example, into a magnetic resonance machine with a mode of operation comparable to that of the magnetic resonance machine 1, and the cause of the fault can be determined. Finally, the result can be transmitted to the magnetic resonance machine 1, thus rendering it possible to work toward having the fault no longer occur in future.

The invention has been explained above using the example of a magnetic resonance machine. However, the invention is not restricted to magnetic resonance machines, but can also be used with other medical devices, for example with computer tomographs.

1. A method for determining the cause of a fault that, during the operation of a medical device (1), can occur in the medical device (1), the method comprising: storing over a specific period of time data that are required for an analysis of the operations that have proceeded before the occurrence of a fault in the medical device (1) in a first, provisional data memory (3); and transferring the content of the first, provisional data memory (3) into a second data memory (4) after the occurrence of a fault.

2. The method as claimed in claim 1, wherein the transfer of the content of the first, provisional data memory (3) into the second data memory (4) can be prompted manually.

3. The method as claimed in claim 1, wherein the transfer of the content of the first, provisional data memory (3) into the second data memory (4) can be prompted automatically.

4. The method as claimed in claim 1, wherein the data are status files, dynamic registers, input data, data or actions generated by the medical device (1), screen displays of the medical device (1) and/or video data generated with the medical device (1).

5. The method as claimed in claim 1, wherein the content of the data memory (3, 4) is transmitted to a computing device (5) of a service center (8).

6. The method as claimed in claim 1, wherein the stored data can be read once more into the medical device (1) or into a device similar to the medical device (1) in order to analyze the operations in the medical device (1).

7. A medical device comprising a first, provisional data memory (3) for storing over a specific period of time the data required to determine the cause of a fault that, during the operation of the medical device (1), can occur in the medical device (1) and required for an analysis of the operations that have proceeded in the medical device (1) before the occurrence of the fault; and a second data memory (4) into which the content of the first, provisional data memory (3) can be transferred after the occurrence of the fault.

8. The medical device as claimed in claim 7, further comprising an actuating device (12) for triggering the transfer of the content of the first, provisional data memory (3) into the second data memory (4).

9. The medical device as claimed in claim 7, further comprising a computing device (5) that monitors the current operating data of the medical device (1) for the occurrence of a fault and, in the event of determining a fault, can automatically prompt the transfer of the content of the first, provisional data memory (3) into the second data memory (4).

10. The medical device as claimed in claim 7, wherein the data are status files, dynamic registers, input data, data or actions generated by the medical device (1), screen displays of the medical device (1) and/or video data generated with the medical device (1).

11. The medical device as claimed in claim 7, wherein the medical device is structured and arranged to be connected to a communications network (7), it being possible to transmit the content of the data memory (3, 4) via the communications network (7) to a computing device (5) of a service center (8).

12. The medical device as claimed in claim 7, further comprising an interface (10) via which the stored data can be read once more into the medical device (1) in order to analyze the operations in the medical device (1).

13. The method as claimed in claim 2, wherein the data are status files, dynamic registers, input data, data or actions generated by the medical device (1), screen displays of the medical device (1) and/or video data generated with the medical device (1).

14. The method as claimed in claim 3, wherein the data are status files, dynamic registers, input data, data or actions generated by the medical device (1), screen displays of the medical device (1) and/or video data generated with the medical device (1).

15. The method as claimed in claim 13, wherein the content of the data memory (3, 4) is transmitted to a computing device (5) of a service center (8).

16. The method as claimed in claim 14, wherein the content of the data memory (3, 4) is transmitted to a computing device (5) of a service center (8).

17. The medical device as claimed in claim 8, further comprising a computing device (5) that monitors the current operating data of the medical device (1) for the occurrence of a fault and, in the event of determining a fault, can automatically prompt the transfer of the content of the first, provisional data memory (3) into the second data memory (4).

18. The medical device as claimed in claim 8, wherein the medical device is structured and arranged to be connected to a communications network (7), it being possible to transmit the content of the data memory (3, 4) via the communications network (7) to a computing device (5) of a service center (8).

19. The medical device as claimed in claim 9, wherein the medical device is structured and arranged to be connected to a communications network (7), it being possible to transmit the content of the data memory (3, 4) via the communications network (7) to a computing device (5) of a service center (8).

20. The medical device as claimed in claim 17, further comprising an interface (10) via which the stored data can be read once more into the medical device (1) in order to analyze the operations in the medical device (1).
